(19) United States
(12) Patent Application Publication
(10) Pub. No.: US 2016/0099491 A1
(43) Pub. Date: Apr. 7, 2016

(54) BATTERY PACK HAVING HEAT RADIATION STRUCTURE

(71) Applicant: SAMSUNG SDI CO., LTD., Yongin-si (KR)

(72) Inventors: Man-Sik CHO, Yongin-si (KR); Sun-Hye HU, Yongin-si (KR)

(21) Appl. No.: 14/729,359

(22) Filed: Jun. 3, 2015

(30) Foreign Application Priority Data
Oct. 1, 2014 (KR) 10-2014-0132438

(51) Int. Cl. H01M 10/6555

(52) U.S. Cl. CPC H01M 10/6555

(57) ABSTRACT

A battery pack, including a battery case; a plurality of batteries in the battery case, each of the plurality of batteries extending in a first direction; and a heat radiation member between adjacent batteries and receiving the adjacent batteries on opposite sides, the heat radiation member including a pair of holders to fix opposite ends of the adjacent batteries; a pair of coupling portions extending in the first direction from between the pair of holders and coupling the pair of holders; and a space portion between the pair of holders and the pair of coupling portions.

### CROSS-REFERENCE TO RELATED APPLICATION

Korean Patent Application No. 10-2014-0132438, filed on Oct. 1, 2014, in the Korean Intellectual Property Office, and entitled: “Battery Pack Having Heat Radiation Structure,” is incorporated by reference herein in its entirety.

### BACKGROUND

Embodiments relate to a battery pack having a heat radiation structure.

### SUMMARY

Embodiments may be realized by providing a battery pack, including a battery case; a plurality of batteries in the battery case, each of the plurality of batteries extending in a first direction; and a heat radiation member between adjacent batteries and receiving the adjacent batteries on opposite sides, the heat radiation member including a pair of holders to fix opposite ends of the adjacent batteries; a pair of coupling portions extending in the first direction from between the pair of holders and coupling the pair of holders; and a space portion between the pair of holders and the pair of coupling portions.

The pair of holders of the heat radiation member may include a first holder fixing the adjacent batteries by contacting one end portions of the adjacent batteries; and a second holder fixing the adjacent batteries by contacting other end portions of the adjacent batteries.

The pair of holders may extend in a second direction and may be I-shaped, the second direction being orthogonal to the first direction, and left and right sides of the I-shaped holders may be curve-shaped or rectangular-shaped depending on a shape of the adjacent batteries to closely or tightly fit the holders and the adjacent batteries together.

The pair of coupling portions of the heat radiation member may couple the pair of holders without contacting the adjacent batteries, and the pair of coupling portions may have quadrangle- or triangle-shaped cross sections.

The space portion of the heat radiation member may be formed by the pair of holders holding the adjacent batteries by contacting the adjacent batteries and the pair of coupling portions coupling the pair of holders without contacting the adjacent batteries, and heated air that may be collected in the space portion may be discharged to outside via at least one of the holders of the heat radiation member.

The pair of holders of the heat radiation member may each further include a heat radiation hole connecting the space portion to outside the battery case.

At least one of the pair of holders of the heat radiation member may include a thermal conductive material.

The thermal conductive material may include anodized aluminum.

The battery pack may further include a lead plate provided on a front surface or a rear surface of the battery case electrically coupling the plurality of batteries.

The plurality of batteries may be cylindrical shaped secondary batteries.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a battery pack according to an embodiment;

FIG. 2 illustrates a perspective view of a heat radiation member between batteries according to an embodiment;

FIG. 3 illustrates a perspective view of a battery pack according to an embodiment;

FIG. 4 illustrates a perspective view of a battery pack according to another embodiment;

FIG. 5 illustrates an exploded view of a battery pack according to another embodiment;

FIG. 6 illustrates a perspective view of a heat radiation member between batteries according to another embodiment; and

FIG. 7 illustrates a perspective view of a battery pack according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

When an element is referred to as being “on” another element, it can be directly on the other element or be indirectly on the other element with one or more intervening elements interposed therebetween. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers are exaggerated for clarity and not necessarily drawn to scale.

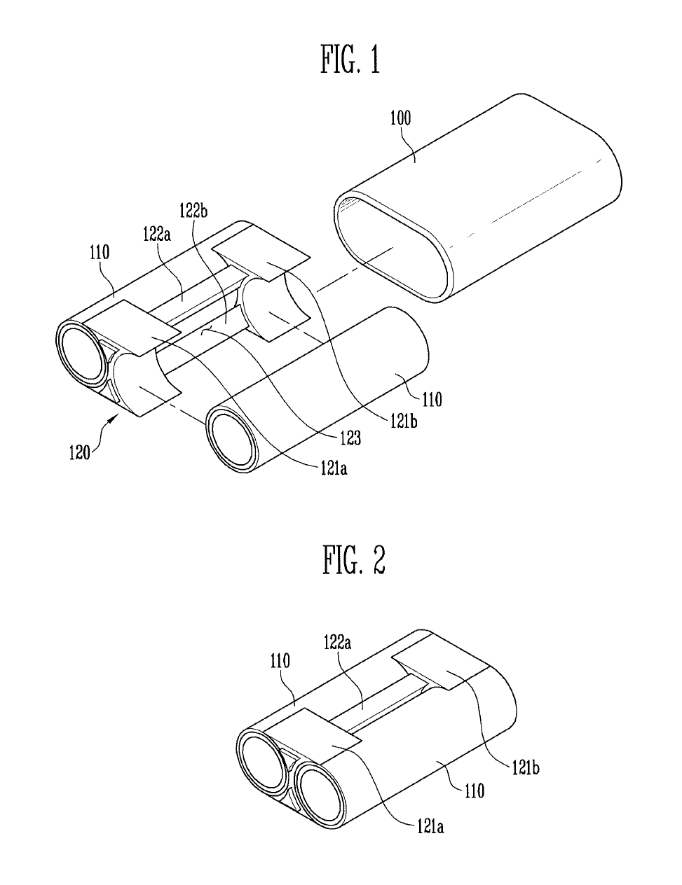

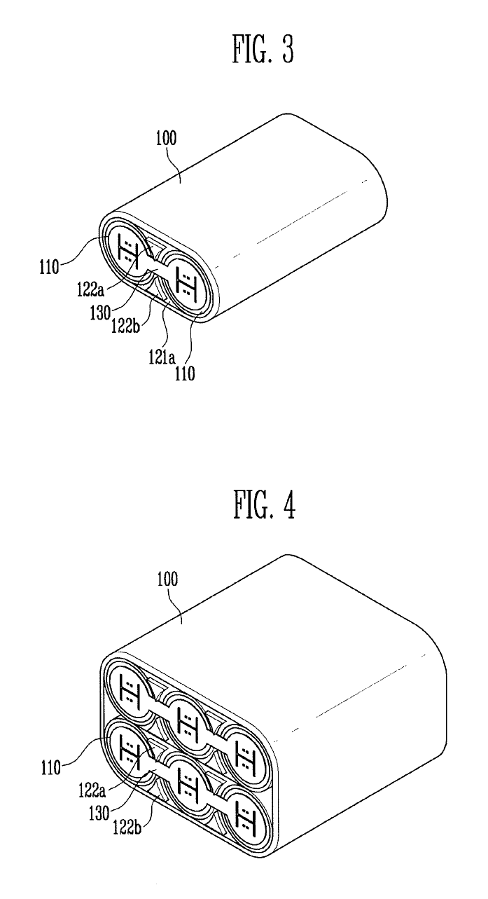

FIG. 1 illustrates an exploded perspective view of a battery pack according to an embodiment. FIG. 2 illustrates a perspective view of a heat radiation member between batteries according to an embodiment. FIG. 3 illustrates a perspective view of a battery pack according to an embodiment. Referring to FIGS. 1 to 3, the battery pack may include a battery case 100, a plurality of batteries 110 received by the battery case 100, each of the batteries 110 extending in a first direction, heat radiation members 120 interposed between batteries that may be adjacent to each other. The heat radiation members 120 may receive batteries on both sides.

The battery case 100 may change in form in various manners depending on the number or shape of the batteries received by the battery case. A cross section of the battery case 100 shown in FIG. 1 is oval shaped. FIG. 1 illustrates the battery case 100 receiving, for example, two cylindrical shaped batteries.

The battery case 100 may be formed in a single body. The battery case 100 may be assembled in parts, for example, an upper battery case and a lower battery case. The upper and lower battery cases may be symmetrical to each other. The upper and lower battery cases may face each other. The parts that couple to each other may have shapes that are complementary to each other to fit together.

Materials for the battery case 100 may be what are used in the industry. The materials for the battery case 100 may have thermal conductivity.

The plurality of batteries 110 received by the battery case 100 and each extending in the first direction may be rechargeable secondary batteries. For example, the batteries may be lithium ion secondary batteries with superior output and capacity. In an embodiment, nickel-cadmium secondary batteries, nickel-hydrogen secondary batteries, and lithium batteries, for example, may be used. The batteries 110 may be charged or discharged in high currents of 1,000 mA or greater, for example, in 1,800 mA. A heat radiation member may be provided, and temperature increase, deterioration, or malfunction may be prevented as the batteries are charged and discharged. Heat that is generated from each battery 110 may be collected into heat radiation areas and may be discharged to outside by means of air flow through the heat radiation member.

The battery case 100 may receive a pair of the batteries 110, each of the batteries extending in the first direction. The heat radiation member 120 may be interposed between the pair of batteries 110. The heat radiation member 120 may receive the batteries on both sides.

The heat radiation member 120 may include a pair of holders 121a and 121b configured to fix or hold both end portions of the batteries 110, a pair of coupling portions 122a and 122b configured to couple the pair of holders and extending in the first direction from between the pair of holders, and space portions 123 between the holders and the coupling portions. The space portions 123 may act as heat radiation areas.

Depending on the shape of the batteries 110 between where the heat radiation members 120 are interposed, the pair of holders 121a and 121b may change in form in various manners and the pair of coupling portions 122a and 122b may change in form in various manners. In FIG. 1, it is illustrated that the pair of batteries 110 that are cylindrical shaped are received, and each of the pair of holders 121 of the heat radiation member 120 is I-shaped. The pair of holders 121a and 121b may include a first holder 121a holding or fixing end portions on one side of the batteries by contacting the end portions on one side of the batteries and a second holder 121b holding or fixing end portions on the other side of the batteries by contacting the end portions on the other side of the batteries.

The pair of holders 121a and 121b may be I-shaped. The pair of holders 121a and 121b may extend in a second direction which may be orthogonal, e.g., vertical, to the first direction. An I-shaped end portion on one side of the holders and an I-shaped end portion on the other side of the holders may be quadrangle- or circle-shaped flat plate. A middle portion may be curve shaped or right-angled, depending on the shape of the batteries. The middle portion and the batteries may be closely or tightly fit together. In FIG. 1, the middle portion may be curve-shaped, and as shown in FIG. 2, end portions on one side of pair of holders 121a and 121b and end portions on the other side of the pair of holders 121a and 121b may be coplanar with the batteries. As the pair of holders 121a and 121b may hold or fix the batteries by contacting the batteries on the left and right sides.

The pair of coupling portions 122a and 122b configured to couple the pair of holders 121a and 121b may similarly change in form depending on the shape of the batteries 110 between which the heat radiation member 120 is interposed. Cross sections of the pair of coupling portions 122a and 122b may be quadrangle- or triangle-shaped rods. According to FIG. 1, the cross sections of the pair of coupling portions 122a and 122b are triangle-shaped rods. Among the pair of coupling portions 122a and 122b, there may be a first coupling portion 122a coupling one end portions of the pair of holders and a second coupling portion 122b coupling other end portions of the pair of holders. The pair of coupling portions 122a and 122b may not contact the batteries.

The pair of holders 121a and 121b and the pair of coupling portions 122a and 122b may be coupled to each other by means of mechanical engagement method or a method such as welding. The pair of holders 121a and 121b and the pair of coupling portions 122a and 122b may be formed in a single body. According to FIGS. 1 to 3, each of the pair of coupling portions 122a and 122b may be coupled to each other by passing through the pair of holders 121a and 121b.

As the batteries are received on both sides by the pair of holders 121a and 121b and the pair of coupling portions 122a and 122b, there may be formed space portions 123. The space portion 123 may act as a heat radiation area. Heat generated from each battery 110 may be collected here and discharged to outside via the pair of holders 121a and 121b by means of air flow.

The holders 121a and 121b may be formed of thermal conductive materials.

The materials may be a material that has good thermal conductivity. The holders 121a and 121b may be formed of anodized aluminum.

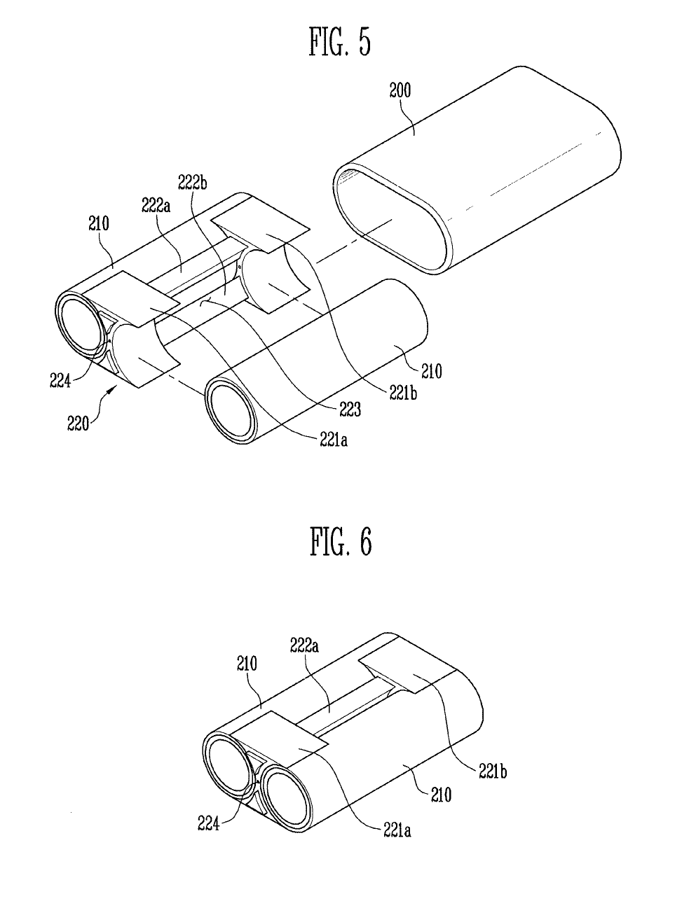

In FIGS. 1 to 3, a battery pack receiving a pair of batteries in a battery case is illustrated. In an embodiment, as shown in FIG. 4, even in the battery pack having the battery case 100 configured to receive the plurality of batteries 110 in layers, there may be provided heat radiation members 120 between adjacent batteries.

The battery pack according to an embodiment may, as shown in FIGS. 3 and 4, include a lead plate 130 provided on a front surface or a rear surface of the battery case and electrically coupling the batteries. The plurality of batteries 110 may be assembled in regular positions corresponding to the position of a cell S defined in the battery case 100. On an outside of the battery case 100, there may be a lead plate 130 coupling the plurality of batteries, which are provided inside, in series or parallel.

The lead plate 130 may couple end portion electrodes of both sides of a battery in series or parallel. For example, the lead plate 130 may couple the batteries provided in a row in parallel and couple parallel blocks that are stacked many layers in series. In an embodiment, the series/parallel coupling structure of the batteries provided inside the battery case and the number or arrangement of the batteries forming parallel blocks, for example, may further vary. In an embodiment, the arrangement of the batteries forming the battery pack may be stacked as shown in the drawings.

There may be an insulation tape attached on an outside of the lead plate 130.

The lead plate 130 may be electrically insulated from an outside environment. The pack battery may detect a voltage state of the battery and include a circuit board (not shown) to control charging and discharging operations. The circuit board may be electrically coupled to the lead plate 130 which forms a current path, and may be coupled to the lead plate 130 via, for example, a lead wire (not shown) taken out from the circuit board.

The circuit board may detect the voltage state of each battery through the lead plate 130 and provide a charging current.

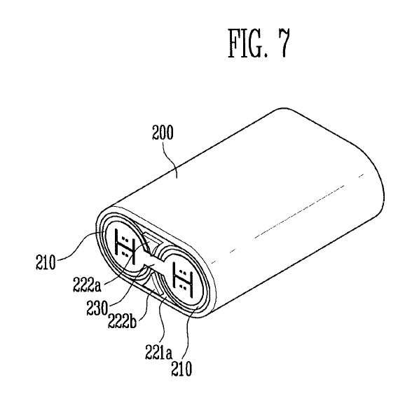

FIGS. 5 to 7 illustrate an embodiment in which the heat radiation member shown in FIGS. 1 to 3 is changed. Referring to FIGS. 5 to 7, the battery pack as shown may include a battery case 200, a plurality of batteries 210 received by the battery case 200 and each extending in a first direction, and heat radiation members 220 provided between batteries and receiving the batteries on both sides.

The battery case 200 may change in form in various manners depending on the number or the shape of the batteries received by the battery case. The battery case 200 shown in FIG. 5 receives two cylindrical shaped batteries and has a cross section which resembles an oval-shaped container.

The battery case 200 may be formed in a single body or may be assembled in parts, an upper battery case and a lower battery case. The upper and lower battery cases may face each other. The upper and lower battery cases may be symmetrical to each other. The parts that couple to each other may have shapes that are complementary to each other to fit together.

Materials for the battery case 200 may be what are used in the industry. The materials for the battery case 200 may have thermal conductivity.

The battery case 200 may receive a pair of the batteries 210, each of the batteries extending in the first direction. The heat radiation member 220 may be interposed between the pair of batteries 210. The heat radiation member 220 may receive the batteries on both sides.

The heat radiation member 220 may include a pair of holders 221a and 221b configured to fix or hold both end portions of the batteries 210, a pair of coupling portions 222a and 222b configured to couple the pair of holders and extending in the first direction from between the pair of holders, and space portions 223 between the holders and the coupling portions. The space portions 223 may act as the heat radiation areas.

Depending on the shape of the batteries 210 between where the heat radiation members 220 are interposed, the pair of holders 221a and 221b may change in form in various manners and the pair of coupling portions 222a and 222b may change in form in various manners. In FIG. 5, it is illustrated that the pair of batteries 210 that are cylindrical shaped are received, and each of the pair of holders 221 of the heat radiation member 220 is I-shaped. The pair of holders 221a and 221b may include a first holder 221a holding or fixing end portions on one side of the batteries by contacting the end portions on one side of the batteries and a second holder 221b holding or fixing end portions on the other side of the batteries by contacting the end portions on the other side of the batteries.

There may be provided a heat radiation hole 224 passing through to outside at the pair of holders 221a and 221b. Heated air that is collected in the heat radiation area may be more effectively discharged to outside through the heat radiation hole 224.

The pair of coupling portions 222a and 222b configured to couple the pair of holders 221a and 221b may similarly change in form depending on the shape of the batteries 210 between which the heat radiation member 220 is interposed. Cross sections of a pair of coupling portions 222a and 222b may be quadrangle- or triangle-shaped rods. According to FIG. 5, the cross sections of the pair of coupling portions 222a and 222b are triangle-shaped rods. Among the pair of coupling portions 222a and 222b, there may be a first coupling portion 222a coupling one end portions of the pair of holders and a second coupling portion 222b coupling other end portions of the pair of holders. The pair of coupling portions 222a and 222b may not contact the batteries.

The pair of holders 221a and 221b and the pair of coupling portions 222a and 222b may be coupled to each other by means of mechanical engagement method or a method such as welding. The pair of holders 221a and 221b and the pair of coupling portions 222a and 222b may be formed in a single body. According to FIGS. 5 to 7, each of the pair of coupling portions 222a and 222b may be coupled to each other by passing through the pair of holders 221a and 221b.

As the batteries are received on both sides by the pair of holders 221a and 221b and the pair of coupling portions 222a and 222b, there may be formed space portions 223. The space portion 223 may act as a heat radiation area. Heat generated from each battery 210 may be collected here, discharged to outside via the pair of holders 221a and 221b by means of air flow, and heat discharged to outside may be maximized through the heat radiation hole 224 formed at the pair of holders 221a and 221b.

The holders 221a and 221b may be formed of thermal conductive materials.

The materials may be a material that has good thermal conductivity. The holders 221a and 221b may be formed of anodized aluminum.

By way of summation and review, as batteries provide higher capacity and power, problems associated with temperature increase may be encountered. Although heat may be radiated from a battery pack by forming holes in battery holders, sufficient heat radiation may not be achieved.

Provided is a battery pack having a heat radiation structure. A heat radiation member may be provided between batteries, through which heated air that is collected in a heat radiation area may be discharged to outside. The temperature of the battery may be reduced, and the life of the battery may be extended.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a battery case;
a plurality of batteries in the battery case, each of the plurality of batteries extending in a first direction; and
a heat radiation member between adjacent batteries and receiving the adjacent batteries on opposite sides,
the heat radiation member including:
a pair of holders to fix opposite ends of the adjacent batteries;
a pair of coupling portions extending in the first direction from between the pair of holders and coupling the pair of holders; and
a space portion between the pair of holders and the pair of coupling portions.

2. The battery pack as claimed in claim 1, wherein the pair of holders of the heat radiation member includes:
a first holder fixing the adjacent batteries by contacting one end portions of the adjacent batteries; and
a second holder fixing the adjacent batteries by contacting other end portions of the adjacent batteries.

3. The battery pack as claimed in claim 1, wherein:
the pair of holders extend in a second direction and are I-shaped, the second direction being orthogonal to the first direction, and
left and right sides of the I-shaped holders are curve-shaped or rectangular-shaped depending on a shape of the adjacent batteries to closely or tightly fit the holders and the adjacent batteries together.

4. The battery pack as claimed in claim 1, wherein:
the pair of coupling portions of the heat radiation member couple the pair of holders without contacting the adjacent batteries, and
the pair of coupling portions have quadrangle- or triangle-shaped cross sections.

5. The battery pack as claimed in claim 1, wherein:
the space portion of the heat radiation member is formed by the pair of holders holding the adjacent batteries by contacting the adjacent batteries and the pair of coupling portions coupling the pair of holders without contacting the adjacent batteries, and
heated air that is collected in the space portion is discharged to outside via at least one of the holders of the heat radiation member.

6. The battery pack as claimed in claim 1, wherein the pair of holders of the heat radiation member each further includes a heat radiation hole connecting the space portion to outside the battery case.

7. The battery pack as claimed in claim 1, wherein at least one of the pair of holders of the heat radiation member includes a thermal conductive material.

8. The battery pack as claimed in claim 7, wherein the thermal conductive material includes anodized aluminum.

9. The battery pack as claimed in claim 1, further comprising a lead plate provided on a front surface or a rear surface of the battery case electrically coupling the plurality of batteries.

10. The battery pack as claimed in claim 1, wherein the plurality of batteries are cylindrical shaped secondary batteries.
